(19) United States
(12) Patent Application Publication
(10) Pub. No.: US 2026/0149338 A1
(43) Pub. Date: May 28, 2026

(54) PIEZOELECTRIC MEASURING DEVICE WITH RESISTIVE SENSITIVE ELEMENT FOR MOTOR VEHICLE

(71) Applicant: Continental Automotive Technologies GmbH, Hannover (DE)

(72) Inventors: Thomas MORIN, Toulouse (FR); Hoang Triet NGUYEN, Toulouse (FR); Franck NIECERON, Toulouse (FR)

(73) Assignee: Continental Automotive Technologies GmbH, Hannover (DE)

(21) Appl. No.: 19/351,755

(22) Filed: Oct. 7, 2025

(30) Foreign Application Priority Data
Nov. 22, 2024 (FR) 2412850

(51) Int. Cl. H02K 11/25; G01K 1/024; G01K 7/16; H01M 10/48; H02K 7/00; H02K 11/00; H04B 11/00

(52) U.S. Cl. CPC H02K 11/25; G01K 1/024; G01K 7/16; H01M 10/486; H02K 7/006; H02K 11/0094; H04B 11/00; H01M 2220/20

(57) ABSTRACT

The invention relates to a device (1) for measuring a parameter for a motor vehicle, said device comprising a main module (10) and a remote module (20) comprising a sensitive element (230) that is configured to measure the parameter and a remote piezoelectric transceiver (210) that is configured to generate an ultrasonic measurement signal, which is an image of the measurement signal (S) and proportional to the values of the measured parameter, and to send it to the main module (10).

### CROSS REFERENCE TO RELATED APPLICATION

This application claims priority to French Application No. 2412850, filed Nov. 22, 2024, the contents of such application being incorporated by reference herein.

### FIELD OF THE INVENTION

The present invention relates to the automotive field, and more particularly to a piezoelectric measuring device with a resistive sensitive element for a motor vehicle and to a method for implementing same.

### BACKGROUND OF THE INVENTION

As known, an electric motor comprises a rotor and a stator. Operation of such a motor causes heating of the rotor and stator. However, the rise in temperature of the rotor may cause a loss of performance and demagnetization of the magnets placed inside above a certain temperature, this potentially leading to damage or even failure of the motor. It is therefore necessary to measure the temperature inside the rotor, so as to be able to reduce the speed thereof as its temperature approaches the critical operating limit and thus avoid damage to or failure of the motor.

Because of its rotation during its operation, the temperature of the rotor is difficult to measure directly using wired temperature sensors, and it is therefore estimated via algorithms and models integrated into the control system of the motor.

However, these integrated algorithms and models sometimes make measurement errors of plus or minus 20° C., this being unsatisfactory in the context of controlling the motor to avoid damaging it or its failure.

A simple, reliable and efficient solution allowing these drawbacks to be at least partly overcome would therefore be advantageous.

### SUMMARY OF THE INVENTION

To this end, an aspect of the invention is firstly a device for measuring a parameter for a motor vehicle, said device comprising a main module and a remote module, said main module comprising a control stage and a main piezoelectric transceiver that is configured to transmit an ultrasonic power signal, said control stage being configured to electrically power said main piezoelectric transceiver and to command transmission of an ultrasonic power signal by said main piezoelectric transceiver, said remote module comprising a remote piezoelectric transceiver and a resistive sensitive element that is connected to the terminals of said remote piezoelectric transceiver, said remote piezoelectric transceiver being configured to receive the ultrasonic power signal transmitted by the main piezoelectric transceiver and to electrically power the sensitive element using said ultrasonic power signal, the sensitive element being configured, when electrically powered, to measure the parameter and generate a measurement signal the amplitude of which is proportional to the measured value and deliver said measurement signal to the remote piezoelectric transceiver, said remote piezoelectric transceiver being configured to receive the measurement signal generated by the sensitive element, to generate an ultrasonic measurement signal, which is an image of the measurement signal and proportional to the value of the measured parameter, and to transmit said ultrasonic measurement signal to the main piezoelectric transceiver, the control stage being configured to determine the value of the parameter from the ultrasonic measurement signal received by the main piezoelectric transceiver.

The device according to an aspect of the invention allows remote measurements to be taken via the remote module, by powering the sensitive measuring element with the energy of signals sent by the main module over a wireless link. Thus, the measurements may be taken as close as possible to the magnets, this increasing the performance of the control of the electric machine. An aspect of the invention further makes it possible to dispense with metal barriers such as, for example, the casing and protective flanges, which may at least partly block electromagnetic waves such as those used for Wi-Fi or Bluetooth.

In one embodiment, the main piezoelectric transceiver and the remote piezoelectric transceiver being configured to resonate at least at one given predetermined frequency, the control stage is configured to generate a signal at said at least one predetermined frequency and to deliver the generated signal to the main piezoelectric transceiver and the measurement stage is configured to generate a signal at said at least one predetermined frequency and to deliver the generated signal to the remote piezoelectric transceiver. Such resonance allows the rate of transmission of the ultrasonic signals and the consumption of electrical current to be optimized.

Preferably, the remote piezoelectric transceiver is configured to resonate at two predetermined frequencies, of about 200 kHz and 2 MHz.

Advantageously, the control stage comprises a memory region in which is stored a lookup table that is determined beforehand, for example empirically, and that contains the correspondence between the amplitude of the ultrasonic measurement signal and a range of values of the parameter.

An aspect of the invention also relates to an electric machine for a motor vehicle, said electric machine comprising a stator, a rotor and a measuring device as described above, said electric machine being configured to be mounted in said vehicle in order to drive the wheels of said vehicle to rotate, in which electric machine the main module is mounted on the stator and the remote module is mounted on the rotor.

Advantageously, the remote module is mounted inside the rotor.

In one embodiment, the rotor comprising a shaft comprising a first shaft portion and a second shaft portion that are mounted on the stator via a system of bearings, the first shaft portion having an end face extending orthogonally to the longitudinal axis of rotation of the rotor, the remote piezoelectric transceiver is mounted on said end face and the main piezoelectric transceiver is mounted on a portion of the stator facing said remote piezoelectric transceiver.

An aspect of the invention also relates to a motor-vehicle battery comprising a measuring device as described above, the remote module being mounted such that the sensitive element is placed inside said battery.

An aspect of the invention also relates to a motor-vehicle battery pack comprising a measuring device as described above, comprising at least one remote module mounted such that the sensitive element is placed inside at least one of the batteries of the battery pack.

An aspect of the invention also relates to a motor-vehicle fuel cell comprising a measuring device as described above, the remote module being mounted such that the sensitive element is placed inside said fuel cell.

An aspect of the invention also relates to a motor vehicle comprising a measuring device as described above.

In one embodiment, the vehicle is an electric or hybrid electric vehicle and comprises an electric machine as described above.

In one embodiment, the vehicle comprises a battery or a battery pack or a fuel cell as described above.

An aspect of the invention also relates to a method for measuring a parameter in a motor vehicle using a measuring device as described above, said method comprising the steps of:
commanding, by means of the control stage, transmission of an ultrasonic power signal by the main piezoelectric transceiver,
transmitting, by means of the main piezoelectric transceiver, said ultrasonic power signal,
receiving, by means of the remote piezoelectric transceiver, the transmitted ultrasonic power signal,
electrically powering, by means of the remote piezoelectric transceiver, using the ultrasonic power signal, the sensitive element,
measuring, by means of the sensitive element, the parameter,
generating, by means of the sensitive element, a measurement signal the amplitude of which is proportional to the value of the measured parameter,
transmitting, by means of the sensitive element, said generated measurement signal to the remote piezoelectric transceiver,
generating, by means of the remote piezoelectric transceiver, an ultrasonic measurement signal, which is an image of the measurement signal and the amplitude of which is proportional to the value of the measured parameter,
transmitting said ultrasonic measurement signal to the main piezoelectric transceiver,
receiving, by means of the main piezoelectric transceiver, the ultrasonic measurement signal,
determining, by means of the control stage, the value of the parameter from the ultrasonic measurement signal received by the main piezoelectric transceiver.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 schematically illustrates, in a functional manner, one embodiment of the measuring device according to the invention.

FIG. 2 schematically illustrates one example of an electric machine according to an aspect of the invention.

FIG. 3 schematically illustrates one example of a battery according to an aspect of the invention.

FIG. 4 schematically illustrates one example of a battery pack according to an aspect of the invention.

FIG. 5 schematically illustrates one example of a fuel cell according to an aspect of the invention.

FIG. 6 schematically illustrates one embodiment of the method according to the invention.

FIG. 7 schematically illustrates a simulation obtained with the device according to an aspect of the invention.

### DETAILED DESCRIPTION OF EXEMPLARY EMBODIMENTS

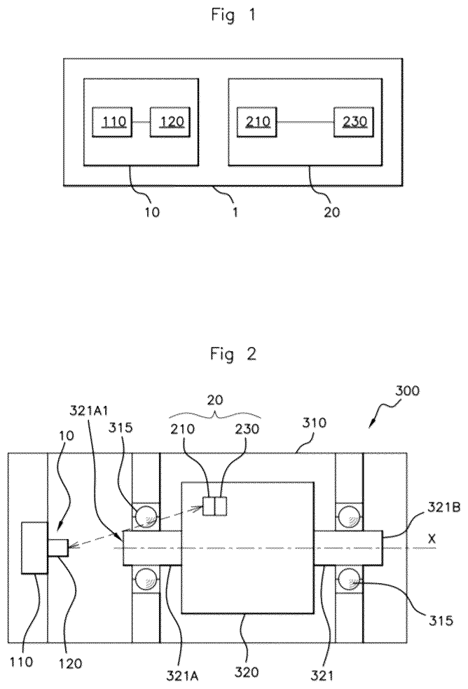

FIG. 1 is one example of a measuring device 1 according to an aspect of the invention. The device 1 is intended to be mounted in a motor vehicle.

The device 1 comprises a main module 10 and a remote module 20.

### Main Module 10

The main module 10 comprises a control stage 110 and a main piezoelectric transceiver 120.

The control stage 110 is configured to electrically power said piezoelectric transceiver and to command transmission of ultrasonic signals by said piezoelectric transceiver, preferably at a resonant frequency of said main piezoelectric transceiver 120.

The main piezoelectric transceiver 120 is configured to transmit and receive ultrasonic signals, called “power” signals SUA, with a view to powering the remote module 20 electrically.

Preferably, the main piezoelectric transceiver 120 is configured to resonate at least at one predetermined frequency, and preferably at two predetermined frequencies, 200 kHz and 2 MHz for example.

### Remote Module 20

The remote module 20 comprises a remote piezoelectric transceiver 210 and a resistive sensitive element 230 that is connected to the terminals of said remote piezoelectric transceiver 210.

The remote piezoelectric transceiver 210 is configured to receive ultrasonic power signals SUA transmitted by the main piezoelectric transceiver 120.

Preferably, the remote piezoelectric transceiver 210 is configured to resonate at least at one predetermined frequency, and preferably at two predetermined frequencies, 200 kHz and 2 MHz for example.

The remote piezoelectric transceiver 210 is configured to receive the ultrasonic power signal SUA transmitted by the main piezoelectric transceiver 120 and to electrically power the sensitive element 230 using said ultrasonic power signal SUA.

The sensitive element 230 is configured, when it is electrically powered by the remote piezoelectric transceiver 210, to measure the parameter, generate a measurement signal S the amplitude of which is proportional to the measured value, and deliver said measurement signal S to the remote piezoelectric transceiver 210.

The measured parameter may be, for example, air temperature, air pressure, moisture content, electric current, mechanical force (stress), torque, etc.

It will be noted that the remote module 20 may comprise more than one sensitive element in order to measure a plurality of different parameters and/or a plurality of identical parameters at various locations.

The remote piezoelectric transceiver 210 is configured to receive the measurement signal S generated by the sensitive element 230 with a view to generating an ultrasonic measurement signal SUM that is an image of the measurement signal S and that is proportional to the value of the measured parameter. The ultrasonic measurement signal generated by the remote piezoelectric transceiver 210 takes the form of an echo when said remote piezoelectric transceiver 210 is electrically powered by the measurement signal S.

The remote piezoelectric transceiver 210 is configured to transmit said ultrasonic measurement signal SUM to the main piezoelectric transceiver 120.

The main piezoelectric transceiver 120 is configured to receive the ultrasonic measurement signal SUM and transmit it to the control stage 110.

The control stage 110 is configured to determine the value of the parameter from the ultrasonic measurement signal SUM received by the main piezoelectric transceiver 120.

The measured value may for example be determined from the amplitude of the ultrasonic measurement signal through use of a lookup table stored in a memory region of the control stage 110. Such a table may have been determined empirically beforehand.

### Examples of Use of the Measuring Device According to an Aspect of the Invention

### Example 1: Electric Machine 300

FIG. 2 shows one example of an electric machine 300 for a motor vehicle. The electric machine 300 is configured to be mounted in the vehicle in order to drive the wheels of said vehicle to rotate.

The electric machine 300 comprises a stator 310, a rotor 320, and a device 1 as described above.

The main module 10 is mounted on the stator 310 and the remote module 20 is mounted on the rotor 320.

The rotor 320 is configured to rotate about a longitudinal axis X.

In this example, the rotor 320 comprises an integral shaft 321 extending along the longitudinal axis X of rotation and containing a first shaft portion 321A and a second shaft portion 321B that are connected to the stator 310 via a system of bearings 315.

The first shaft portion 321A comprises an end face 321A1 extending orthogonally to the longitudinal axis X of rotation of the rotor 320. The remote piezoelectric transceiver 210 is mounted on said end face 321A1 and the main piezoelectric transceiver 120 is mounted on a portion of the stator 310 facing said remote piezoelectric transceiver 21.

### Example 2: Battery 400

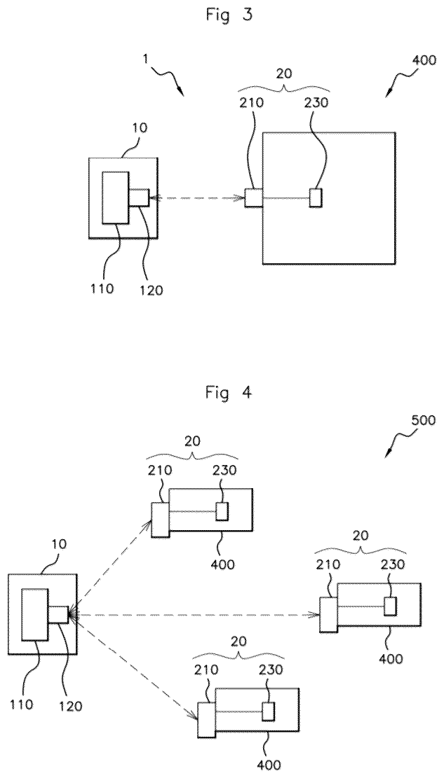

FIG. 3 is an example of a battery 400 for a motor vehicle.

The main module 10 is placed away from the battery 400 while the remote module 20 is mounted on the battery 400 such that the sensitive element 230 measures a parameter inside said battery 400, for example temperature or pressure, moisture content, electric current, mechanical force (stress), torque, etc.

It will be noted that the remote piezoelectric transceiver 210 and the measurement stage 220 may be mounted on an external face of the battery 400 or inside the battery 400 with the sensitive element 230, as in example 1 of an electric machine.

### Example 3: Battery Pack 500

FIG. 4 is an example of a battery pack 500 for a motor vehicle.

The main module 10 is placed away from the battery pack 500 while one or more respective remote modules 20 are mounted on one or more of the batteries 400 of the battery pack 500 such that the sensitive element 230 of each remote module 20 measures a parameter inside of each battery 400, temperature or pressure for example.

### Example 4: Fuel Cell 600

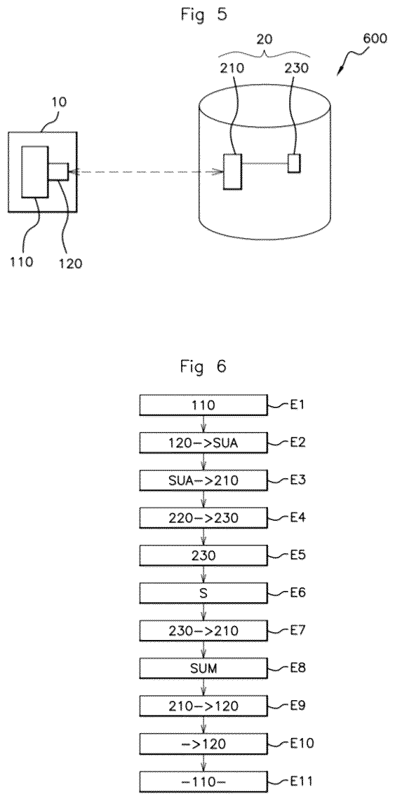

FIG. 5 is an example of a fuel cell 600 for a motor vehicle.

The main module 10 is placed away from the fuel cell 600 while the remote module 20 is mounted on the fuel cell 600 such that the sensitive element 230 measures a parameter inside said fuel cell 600, for example in the circuit for supplying air to the membranes of the fuel cell 600. Once again, the measured parameter(s) may for example be temperature, pressure, moisture content, electric current, mechanical force (stress) and/or torque.

### Example of Implementation

One example of implementation of the device 1 will now be described with reference to FIG. 6. In this non-limiting example, the parameter to be measured may for example be temperature, in particular inside a rotor 320 of an electric machine 300.

Firstly, when it is necessary to measure the parameter, the control stage 110 of the main module 10 commands, in a step E1, transmission of an ultrasonic power signal SUA by the main piezoelectric transceiver 120, preferably at one of the resonant frequencies to improve the quality of transmission of said ultrasonic power signal SUA.

In a step E2, the main piezoelectric transceiver 120 transmits the ultrasonic power signal SUA, which is received by the remote piezoelectric transceiver 210 in a step E3.

In a step E4, the remote piezoelectric transceiver 210 electrically powers the sensitive element 230 with the ultrasonic power signal SUA.

Once powered electrically, the sensitive element 230 measures, in a step E5, the parameter of interest, which may for example be air temperature, air pressure, moisture content, electric current, mechanical force (stress) or torque.

During the measurement of the parameter, the sensitive element 230 generates, in a step E6, a measurement signal S the amplitude of which varies with the value of the measured parameter, the resistance of the sensitive element 230 varying with the parameter, temperature for example.

The generated measurement signal S is transmitted, in a step E7, to the remote piezoelectric transceiver 210, which generates, in a step E8, in response to reception of the measurement signal S, an ultrasonic measurement signal SUM that is the image of the measurement signal S, i.e. the amplitude of which is proportional to the measured value. By “image”, what is meant is that the signal is identical or proportional, i.e. its amplitude is larger or smaller but varies proportionally to the amplitude of the measurement signal S.

The ultrasonic measurement signal SUM is transmitted, in a step E9, by the remote piezoelectric transceiver 210 to the main piezoelectric transceiver 120, which receives it and transmits it to the control stage 110 in a step E10.

The control stage 110 then determines, in a step E11, the value of the parameter from the ultrasonic measurement signal SUM received by the main piezoelectric transceiver 120, for example using the predetermined lookup table stored in its memory region.

### Simulation

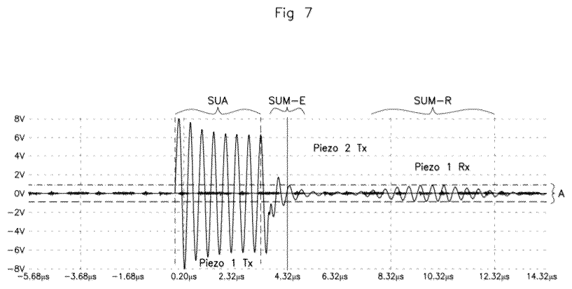

FIG. 7 illustrates one example of a simulation carried out with the device 1 according to an aspect of the invention.

The ultrasonic power signal SUA transmitted by the main piezoelectric transceiver 120 has a substantially sinusoidal shape.

In response (or in echo) to excitation by said ultrasonic power signal SUA, the remote piezoelectric transceiver 210 generates and transmits an ultrasonic measurement signal SUM-E that will reach an amplitude A once stabilized at the second oscillation, the amplitude A being proportional to the temperature value measured by the resistive sensitive element 230, and more precisely to the resistance of said sensitive element 230, which varies with temperature. The ultrasonic measurement signal SUM-R that is received by the main piezoelectric transceiver 120 has an increasing then decreasing sinusoidal shape and therefore the maximum amplitude corresponds to the amplitude A and therefore to the measured temperature value.

The invention therefore makes it possible to measure a parameter with a remote module that is supplied with electrical power wirelessly, thus avoiding use of a replaceable battery, something that is particularly advantageous in the case of a rotor of an electric machine.

1. A device for measuring a parameter for a motor vehicle, said device comprising a main module and a remote module, said main module comprising a control stage and a main piezoelectric transceiver that is configured to transmit an ultrasonic power signal said control stage being configured to electrically power said main piezoelectric transceiver and to command transmission of an ultrasonic power signal by said main piezoelectric transceiver, said remote module comprising a remote piezoelectric transceiver and a resistive sensitive element that is connected to the terminals of said remote piezoelectric transceiver, said remote piezoelectric transceiver being configured to receive the ultrasonic power signal transmitted by the main piezoelectric transceiver and to electrically power the sensitive element using said ultrasonic power signal, the sensitive element being configured, when electrically powered, to measure the parameter and generate a measurement signal the amplitude of which is proportional to the measured value and deliver said measurement signal to the remote piezoelectric transceiver, said remote piezoelectric transceiver being configured to receive the measurement signal generated by the sensitive element, to generate an ultrasonic measurement signal, which is an image of the measurement signal and proportional to the value of the measured parameter, and to transmit said ultrasonic measurement signal to the main piezoelectric transceiver, the control stage being configured to determine the value of the parameter from the ultrasonic measurement signal received by the main piezoelectric transceiver.

2. The device as claimed in claim 1, wherein, the main piezoelectric transceiver and the remote piezoelectric transceiver being configured to resonate at least at one given predetermined frequency, the control stage is configured to generate a signal at said at least one predetermined frequency and to deliver the generated signal to the main piezoelectric transceiver and the measurement stage is configured to generate a signal at said at least one predetermined frequency and to deliver the generated signal to the remote piezoelectric transceiver.

3. The device as claimed in claim 2, wherein the remote piezoelectric transceiver is configured to resonate at two predetermined frequencies, of about 200 kHz and 2 MHz.

4. The device as claimed in claim 1, wherein the control stage comprises a memory region in which is stored a lookup table that is determined beforehand, for example empirically, and that contains the correspondence between the amplitude of the ultrasonic measurement signal and a range of values of the parameter.

5. An electric machine for a motor vehicle, said electric machine comprising a stator, a rotor and a device as claimed in claim 1, said electric machine being configured to be mounted in said vehicle in order to drive the wheels of said vehicle to rotate, in which electric machine the main module is mounted on the stator and the remote module is mounted on the rotor.

6. The electric machine as claimed in claim 5, wherein the remote module is mounted inside the rotor.

7. The electric machine as claimed in claim 5, wherein, the rotor comprising a shaft comprising a first shaft portion and a second shaft portion that are mounted on the stator via a system of bearings, the first shaft portion having an end face extending orthogonally to the longitudinal (X) axis of rotation of the rotor, the remote piezoelectric transceiver is mounted on said end face and the main piezoelectric transceiver is mounted on a portion of the stator facing said remote piezoelectric transceiver.

8. A motor-vehicle battery or battery pack or fuel cell comprising a measuring device as claimed in claim 1, the remote module being mounted so that the sensitive element is placed inside said battery, or inside at least one battery of the battery pack or inside the fuel cell, respectively.

9. A motor vehicle comprising a measuring device as claimed in claim 1.

10. A method for measuring a parameter in a motor vehicle using a measuring device as claimed in claim 1, said method comprising:
commanding, by means of the control stage, transmission of an ultrasonic power signal by the main piezoelectric transceiver,
transmitting by means of the main piezoelectric transceiver said ultrasonic power signal,
receiving, by means of the remote piezoelectric transceiver the transmitted ultrasonic power signal,
electrically powering, by means of the remote piezoelectric transceiver using the ultrasonic power signal the sensitive element,
measuring, by means of the sensitive element, the parameter,
generating, by means of the sensitive element, a measurement signal the amplitude of which is proportional to the value of the measured parameter,
transmitting, by means of the sensitive element, said generated measurement signal to the remote piezoelectric transceiver,
generating, by means of the remote piezoelectric transceiver, an ultrasonic measurement signal, which is an image of the measurement signal and the amplitude of which is proportional to the value of the measured parameter,
transmitting said ultrasonic measurement signal to the main piezoelectric transceiver,
receiving, by means of the main piezoelectric transceiver, the ultrasonic measurement signal,
determining, by means of the control stage, the value of the parameter from the ultrasonic measurement signal received by the main piezoelectric transceiver AMENDMENTS TO THE DRAWINGS:
The attached sheets of drawings include changes to Figs 1-7 These sheets, which include Figs. 1-7, replace the original sheets including Fig. 1-7. Attachment: Replacement Sheets
